(19) United States
(12) Patent Application Publication
(10) Pub. No.: US 2014/0116388 A1
(43) Pub. Date: May 1, 2014

(54) FUEL SYSTEM RETROFIT KIT FOR AN ENGINE

(71) Applicant: ELECTRO-MOTIVE DIESEL, INC., La Grange, IL (US)

(72) Inventors: Aaron G. Foege, Westmont, IL (US); Farhan Devani, Morton Grove, IL (US); Edward J. Cryer, III, Homer Glen, IL (US); Dave Osthoff, Tinley Park, IL (US)

(73) Assignee: ELECTRO-MOTIVE DIESEL, INC., La Grange, IL (US)

(21) Appl. No.: 13/665,591

(22) Filed: Oct. 31, 2012

(51) Int. Cl. F02M 69/50

(52) U.S. Cl. 123/456

(57) ABSTRACT

A retrofit kit for converting a single-fuel engine having an air box to run on two different fuels is disclosed. The kit may have at least one gaseous fuel injector mountable inside the air box and associated with each cylinder of the engine. The kit may further have a common flow regulator. The kit may also have at least one individual fuel supply line configured to connect the common flow regulator to the at least one gaseous fuel injector. The kit may additionally have a fuel supply and a common fuel supply line configured to connect the common flow regulator to the fuel supply.

### TECHNICAL FIELD

The present disclosure is directed to a fuel system and, more particularly, to a fuel system in the form of a retrofit kit for an engine.

### BACKGROUND

Due to the rising cost of liquid fuel (e.g. diesel fuel) and ever increasing restrictions on exhaust emissions, engine manufacturers have developed dual-fuel engines. An exemplary dual-fuel engine provides injections of a low-cost gaseous fuel (e.g. natural gas) through air intake ports of the engine's cylinders. The gaseous fuel is introduced with clean air that enters through the intake ports and is ignited by liquid fuel that is injected during each combustion cycle. Because a lower-cost fuel is used together with liquid fuel, cost efficiency may be improved. In addition, the combustion of the gaseous and liquid fuel mixture may result in a reduction of harmful emissions.

One exemplary dual-fuel solution is to provide a separate injection of a gaseous fuel through an inlet located in an air intake port of the cylinder. This allows the gaseous fuel to be introduced with the clean air that enters through the intake ports and mix with liquid fuel that is injected for each new combustion cycle. This solution can be implemented as a retrofit kit to be installed on an existing single-fuel engine to convert the engine to be dual-fuel.

An exemplary retrofit kit is disclosed in European Patent Document EP 2441941 ('941 document) to Trzmiel, published Apr. 4, 2012. In particular, the '941 document discloses a system that can be utilized as a retrofit assembly for adapting a diesel-only engine to be dual-fuel. The assembly includes a plate that attaches injector nozzles to the cylinder heads of the engine. The injector nozzles are connected to a gas source for injecting gaseous fuel into the cylinders through intake ports in the cylinder heads. The gaseous fuel is injected into and mixes with the stream of air that is let into the cylinder when the intake valve is opened.

Although the assembly of the '941 document can adapt an engine to be dual-fuel, it may do so less than optimally. The injection nozzles may be attached such that they inject the gaseous fuel into the stream of intake air that is let in through an intake valve in the cylinder head. This is an indirect injection that can result in less control over the flow of gaseous fuel into the cylinder. Further, permanent modifications to the engine in order to introduce the injector nozzles into the system may be required.

The disclosed retrofit kit is directed to overcoming one or more of the problems set forth above and/or other problems of the prior art.

### SUMMARY

In one aspect, the present disclosure is directed to a retrofit kit for converting a single-fuel engine having an air box to run on two different fuels. The kit may include at least one gaseous fuel injector mountable inside the air box and associated with each cylinder of the engine. The kit may further include a common flow regulator. The kit may also include at least one individual fuel supply line configured to connect the common flow regulator to the at least one gaseous fuel injector. The kit may additionally include a fuel supply and a common fuel supply line configured to connect the common flow regulator to the fuel supply.

In another aspect, the present disclosure is directed to a method of retrofitting a single-fuel engine having an air box to run on two different fuels. The method may include mounting a first gaseous fuel injector to one of an air box wall and a cylinder liner such that the first gaseous fuel injector is capable of injecting fuel into an existing cylinder of the engine. The method may further include connecting a common flow regulator to the first gaseous fuel injector and connecting a fuel supply to the common flow regulator.

### BRIEF DESCRIPTION OF THE DRAWINGS

FIG. 1 is a cross-sectional illustration of a dual-fuel engine equipped with an exemplary disclosed fuel system;

FIG. 2 is a pictorial illustration of an exemplary disclosed fuel injector that may be used in conjunction with the fuel system of FIG. 1;

FIG. 3 is a top-view illustration inside of a cylinder of the engine of FIG. 1; and

FIG. 4 is a schematic illustration of an exemplary disclosed fuel system retrofit kit that may be used in conjunction with the engine of FIG. 1.

### DETAILED DESCRIPTION

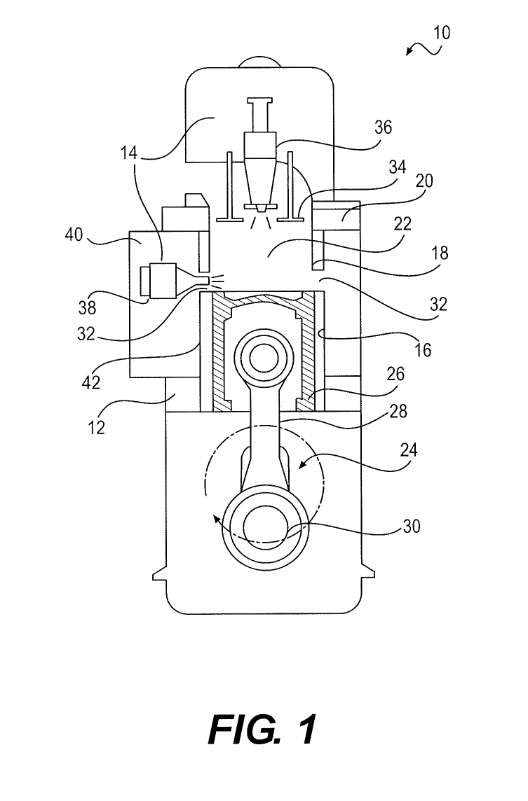

FIG. 1 illustrates an exemplary internal combustion engine 10. Engine 10 is depicted and described as a two-stroke dual-fuel engine. Engine 10 may include an engine block 12 that at least partially defines a plurality of cylinders 16 (only one shown), each having an associated cylinder head 20. A cylinder liner 18 may be disposed within each engine cylinder 16, and cylinder head 20 may close off an end of liner 18. A piston 24 may be slidably disposed within each cylinder liner 18. Each cylinder liner 18, cylinder head 20, and piston 24 may together define a combustion chamber 22 that receives fuel from a fuel system 14 mounted to engine 10. It is contemplated that engine 10 may include any number of engine cylinders 16 with corresponding combustion chambers 22.

Within engine cylinder liner 18, piston 24 may be configured to reciprocate between a bottom-dead-center (BDC) or lower-most position, and a top-dead-center (TDC) or upper-most position. In particular, piston 24 may be an assembly that includes a piston crown 26 pivotally connected to a rod 28, which may in turn be pivotally connected to a crankshaft 30. Crankshaft 30 of engine 10 may be rotatably disposed within engine block 12 and each piston 24 coupled to crankshaft 30 by rod 28 so that a sliding motion of each piston 24 within liner 18 results in a rotation of crankshaft 30. Similarly, a rotation of crankshaft 30 may result in a sliding motion of piston 24. As crankshaft 30 rotates through about 180 degrees, piston crown 26 and connected rod 28 may move through one full stroke between BDC and TDC. Engine 10, being a two-stroke engine, may have a complete cycle that includes a power/exhaust/intake stroke (TDC to BDC) and an intake/compression stroke (BDC to TDC).

During a final phase of the power/exhaust/intake stroke described above, air may be drawn into combustion chamber 22 via one or more gas exchange ports (e.g., air intake ports) 32 located within a sidewall of cylinder liner 18. In particular, as piston 24 moves downward within liner 18, a position will eventually be reached at which air intake ports 32 are no longer blocked by piston 24 and instead are fluidly communicated with combustion chamber 22. When air intake ports 32 are in fluid communication with combustion chamber 22 and a pressure of air at air intake ports 32 is greater than a pressure within combustion chamber 22, air will pass through air intake ports 32 into combustion chamber 22. It is contemplated that gaseous fuel (e.g. methane or natural gas), may be introduced into combustion chamber 22 (e.g. radially injected) through at least one of air intake ports 32. The gaseous fuel may mix with the air to form a fuel/air mixture within combustion chamber 22.

Eventually, piston 24 will start an upward movement that blocks air intake ports 32 and compresses the air/fuel mixture. As the air/fuel mixture within combustion chamber 22 is compressed, a temperature of the mixture may increase. At a point when piston 24 is near TDC, a liquid fuel (e.g. diesel or other petroleum-based liquid fuel) may be injected into combustion chamber 22 via a liquid fuel injector 36. The liquid fuel may be ignited by the hot air/fuel mixture, causing combustion of both types of fuel and resulting in a release of chemical energy in the form of temperature and pressure spikes within combustion chamber 22. During a first phase of the power/exhaust/intake stroke, the pressure spike within combustion chamber 22 may force piston 24 downward, thereby imparting mechanical power to crankshaft 30. At a particular point during this downward travel, one or more gas exchange ports (e.g., exhaust ports) 34 located within cylinder head 20 may open to allow pressurized exhaust within combustion chamber 22 to exit and the cycle will restart.

Liquid fuel injector 36 may be positioned inside cylinder head 20 and configured to inject liquid fuel into a top of combustion chamber 22 by releasing fuel axially towards an interior of cylinder liner 18 in a generally cone-shaped pattern. Liquid fuel injector 36 may be configured to cyclically inject a fixed amount of liquid fuel, for example, depending on a current engine speed and/or load. In one embodiment, engine 10 may be arranged to run on liquid fuel injections alone or a smaller amount of liquid fuel mixed with the gaseous fuel. The gaseous fuel may be injected through air intake port 32 into combustion chamber 22 via any number of gaseous fuel injectors 38. The gaseous fuel may be injected radially into combustion chamber 22 through a corresponding air intake port 32 after the air intake port 32 is opened by movement of piston 24.

Engine 10, utilizing fuel system 14, may consume two types of fuels when it is run as a dual-fuel engine. It is contemplated that the gaseous fuel may produce between 40% and 85% of a total energy output of engine 10. For example, the gaseous fuel may produce between 60% and 65% of the total energy output, with the liquid fuel producing the remaining 35% to 40%. In any case, the liquid fuel can act as an ignition source such that a smaller amount will be necessary than what is needed for engine 10 if it were running on only liquid fuel.

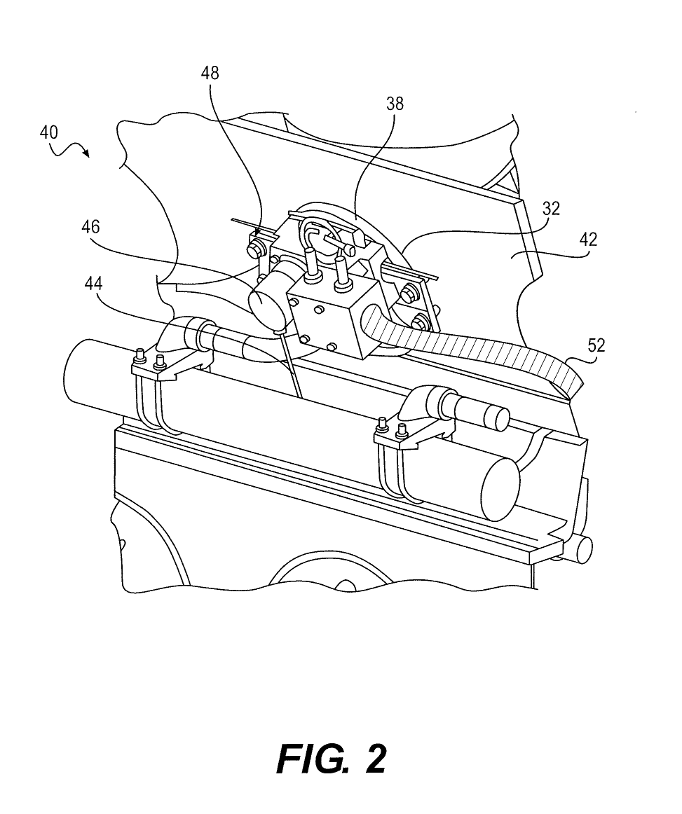

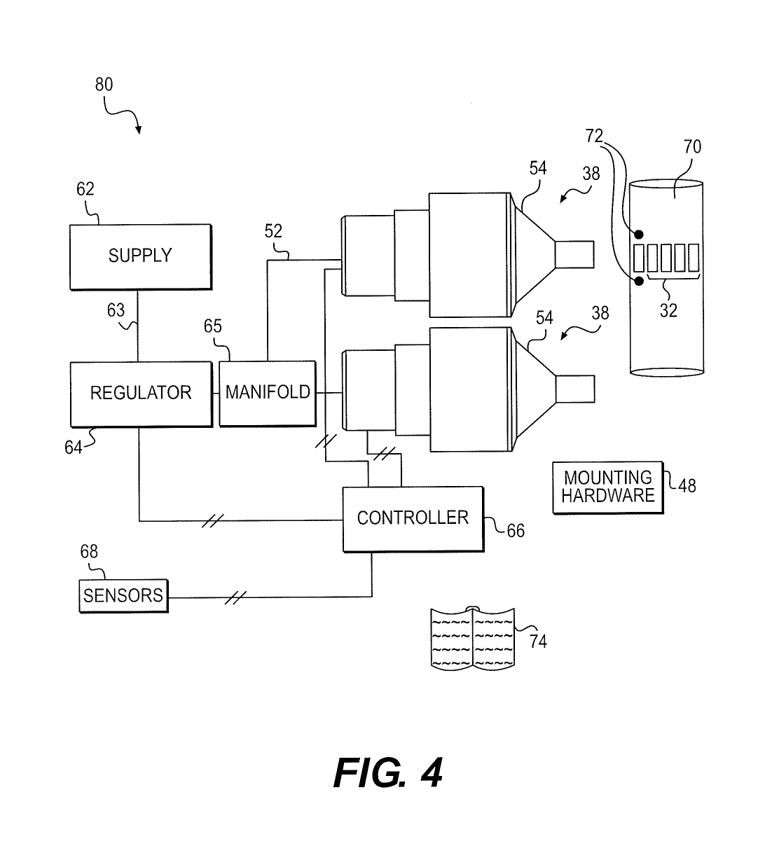

FIG. 2 illustrates a cut-away view inside an air box 40 of engine 10, detailing an exemplary location of gaseous fuel injector 38. Gaseous fuel injector 38 may be positioned adjacent a wall 42 of engine block 12, such that a nozzle 54 (shown only in FIGS. 1, 3, and 4) of gaseous fuel injector 38 is in direct communication with one of air intake ports 32 of an adjacent engine cylinder 16. Gaseous fuel injector 38 may be connected at an opposing external end to power and control components of fuel system 14. These components may include, among other things, wiring 44 to supply electrical power, and a means to convert the electrical power into mechanical power, such as a solenoid 46. Mounting hardware 48 may include a mounting plate and bolts to mount gaseous fuel injector 38 to wall 42 or directly to cylinder liner 18 such that gaseous fuel injector 38 is positioned at an air intake port 32. Fuel system 14 may further include (i.e. in addition to liquid fuel injector 36, gaseous fuel injector 38, wiring 44, and solenoid 46) at least one fuel supply line 52 connected to gaseous fuel injector 38. Supply line 52 may be positioned inside air box 40 and be connected to a fuel supply 62 (shown schematically in FIG. 4) at a distal end. Fuel supply 62 may represent a fuel tank or other container configured to serve as a fuel reservoir. It is contemplated that fuel system 14 may further include a supply manifold 65 (shown schematically in FIG. 4), located within or outside of air box 40, that supplies gaseous fuel to multiple gaseous fuel injectors 38, if desired. Supply manifold 65 may be connected to a common flow regulator 64 (shown schematically in FIG. 4) for controlling the flow of fuel into supply manifold 65.

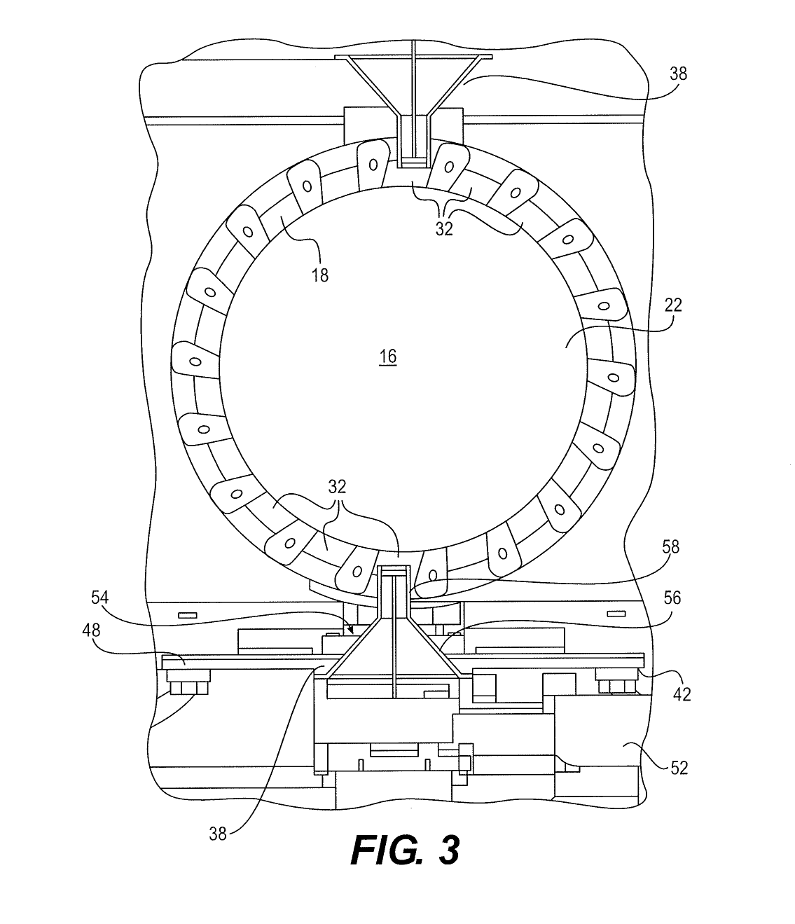

FIG. 3. illustrates a top view inside of cylinder 16. Cylinder 16 may include air intake ports 32 located circumferentially in cylinder liner 18. Each air intake port 32 may be angled to be offset from an associated radial direction 53 of cylinder 16. That is, an axis of air intake port 32 may not pass through an axis of cylinder 16. Air intake ports 32 may be arranged to direct air flow at an oblique horizontal angle of 18° with respect to associated radial direction 53. This orientation of air intake ports 32 may promote a counter-clockwise swirling flow of air from air box 40 into cylinder 16 (as viewed in FIG. 3), which may assist in mixing of the air with the fuel inside combustion chamber 22. Gaseous fuel injectors 38 may be placed in one or more of air intake ports 32 to inject fuel with this air flow.

Gaseous fuel injector 38 may include a nozzle 54, for example a converging nozzle having a converging portion 56 and a tip 58 connected at a distal end of converging portion 56. Tip 58 may create an axial flow path for gaseous fuel directed towards the center axis of cylinder 16. Converging portion 56 may increase upstream pressures of gaseous fuel to be injected into cylinder 16 through downstream tip 58. Converging portion 56 may have an included angle of approximately 60° relative to a center axis, with other angles in the range of about 50 to 70° possible. A pressure of injected gaseous fuel may be higher than that of the air inducted into cylinder 16 from air box 40. It is contemplated that the pressure of injected gaseous fuel may be approximately 2-4 bar greater than the inducted air. This pressure differential may be necessary to allow gaseous fuel to enter cylinder 16 during the time that air intake ports 32 are open and to overcome the flow of air from air box 40 through surrounding air intake ports 32. It is also possible for the higher pressure fuel to help pull air into the cylinder while air intake ports 32 are open.

As also shown in FIG. 3, gaseous fuel injector 38 may be angled differently than air intake port 32. In particular, gaseous fuel injector 38 may be oriented generally towards the axis of cylinder liner 18 or otherwise generally parallel to associated radial direction 53, at a horizontal first oblique angle with respect to air flow through air intake ports 32. Air intake ports 32 may be positioned to direct air flow at an oblique second horizontal angle of about 18° relative to associated radial direction 53. Alternatively, gaseous fuel injector 38 may be aligned with or perpendicular to the air flow direction of air intake ports 32. Tip 58 may be smaller than air intake port 32 such that it may be positioned at least partly in air intake port 32. Further, tip 58 may be located in an upper half of its associated air intake port 32 relative to the axial direction of cylinder liner 18 to allow for fuel injection even after piston 24 has begun to close a bottom portion of air intake ports 32. Gaseous fuel injector 38 may be positioned such that air may flow around nozzle 54, through the associated air intake port 32, and into cylinder 16. In another embodiment, the associated air intake port 32 may be sealed around nozzle 54 to prevent air flow through the same air intake port 32.

FIG. 4 schematically illustrates the components of an exemplary fuel system retrofit kit 80 for engine 10. Retrofit kit 80 may include the components necessary to convert an existing single-fuel (e.g. diesel-only) engine into the dual-fuel engine that has been described above. Retrofit kit 80 may include, among other things, one or more gaseous fuel injectors 38, each including a nozzle 54. One or multiple gaseous fuel injectors 38 may be associated with each cylinder 16. A fuel supply 62, a common fuel supply line 63, a common flow regulator 64, a supply manifold 65, and individual injector fuel supply lines 52 may be included in retrofit kit 80. Control components, including controller 66 and sensors 68, may also be included in kit 80. It is contemplated that sensors 68 may represent one or more performance sensors (e.g. temperature, pressure, and/or knock sensors) configured to generate a signal indicative of a performance condition of the engine after conversion of the engine to run on two different fuels and relay that signal to controller 66. Controller 66 may be capable of further communicating with common flow regulator 64, and/or an existing liquid fuel injector.

Retrofit kit 80 may additionally include one or more replacement cylinder liners 70 that have pre-drilled holes 72 for receiving mounting hardware 48 (e.g. bolts) that mount gaseous fuel injectors 38 at air intake ports 32, either inside air box 40 to wall 42 or directly to cylinder liner 18. Mounting hardware 48 may further include a mounting plate for positioning a gaseous fuel injector 38. If a mounting plate is included, it may include holes for allowing air to flow through, to help prevent mounting hardware 48 from blocking air flow through air intake ports 32. A set of instructions 74 for properly installing the components of kit 80 may also be included. One of ordinary skill in the art would recognize that retrofit kit of FIG. 4 represents an exemplary kit for converting a single fuel engine and that additional and/or different combinations of components may be necessary to complete the conversion of a given engine.

### INDUSTRIAL APPLICABILITY

Fuel system 14 may be retrofitted into an existing single-fuel engine using kit 80 of FIG. 4. Fuel system 14 may be a substitute for a single-fuel system in order to utilize the associated engine in a cleaner and more cost-efficient manner. A possible manner in which one cylinder may be retrofitted by kit 80 of FIG. 4 will now be described. One of ordinary skill in the art would recognize that each cylinder of the engine could be retrofitted in the same manner.

Each gaseous fuel injector 38 may be mounted such that it is positioned to inject gaseous fuel into an air intake port 32 of a cylinder 16. To accomplish this, each gaseous fuel injector 38 may be mounted to wall 42 inside air box 40 or directly to cylinder liner 18. A mounting plate and bolts may be utilized to mount to wall 42, if desired. To mount to cylinder liner 18, mounting holes may be formed within an existing cylinder liner 18 to receive mounting hardware 48. Alternatively, the existing cylinder liner 18 may be replaced with a new and different cylinder liner 70 that already includes pre-drilled holes 72. Mounting hardware 48 (e.g. bolts) may be utilized to mount gaseous fuel injector 38 to engine 10 via the holes in cylinder liner 70. This may be repeated as necessary to provide a desired number of gaseous fuel injectors 38 to engine 10. For instance, a single gaseous fuel injector 38 may be mounted to multiple cylinders 16, multiple gaseous fuel injectors 38 may be mounted to a single cylinder 16, or multiple gaseous fuel injectors 38 may be mounted to each of cylinders 16. For example, a first gaseous fuel injector 38 may be mounted such that its nozzle 54 is inside a first air intake port 32, and a second gaseous fuel injector 38 may be mounted such that its nozzle 54 is in a second air intake port 32 on a generally opposite side of cylinder 16 (See arrangement of FIG. 3). A fuel supply 62 may be connected by way of common fuel supply line 63 to common flow regulator 64 and positioned in range of the engine 10 being converted. Common flow regulator 64 may be connected to supply manifold 65 to distribute fuel through injector supply lines 52 inside air box 40 of engine 10 to gaseous fuel injectors 38. A control system may be installed on engine 10 to manage fuel system 14. The control system may include, among other things, a controller 66 and various sensors 68. The control system may be installed such that controller 66 is capable of communicating with sensors 68 (e.g. to receive data about a condition) and with common flow regulator 64 and/or an existing liquid fuel injector (e.g. to send instructions to adjust the flow of fuel). The resulting retrofitted cylinder may be capable of running as a dual-fuel engine in the manner described in the above section.

The disclosed retrofit kit 80 may be advantageous because it may not require permanent changes to the existing engine. For example, the previously single-fuel system may not need to be modified except to adjust the amount of liquid fuel that is injected into the cylinder. Further, additional modifications may not be required since a replacement liner 70 with pre-drilled holes 72 may be provided with kit 80 for receiving mounting hardware 48.

It will be apparent to those skilled in the art that various modifications and variations can be made to the disclosed engine and fuel system. Other embodiments will be apparent to those skilled in the art from consideration of the specification and practice of the disclosed fuel system. It is intended that the specification and examples be considered as exemplary only, with a true scope being indicated by the following claims and their equivalents.

What is claimed is:

1. A retrofit kit for converting a single-fuel engine having an air box and at least one cylinder to run on two different fuels, the retrofit kit comprising:
at least one gaseous fuel injector mountable inside the air box and associated with each cylinder of the engine;
a common flow regulator;
at least one individual fuel supply line configured to connect the common flow regulator to the at least one gaseous fuel injector;
a fuel supply; and
a common fuel supply line configured to connect the common flow regulator to the fuel supply.

2. The retrofit kit of claim 1, further including mounting hardware to mount the at least one gaseous fuel injector at an air intake port of the associated cylinder.

3. The retrofit kit of claim 2, further including at least one replacement cylinder liner having pre-drilled holes for receiving the mounting hardware.

4. The retrofit kit of claim 1, further including a controller capable of communication with the common flow regulator.

5. The retrofit kit of claim 4, further including at least one sensor capable of communication with the controller, the sensor configured to generate a signal indicative of a performance condition of the engine after conversion of the engine to run on two different fuels.

6. The retrofit of claim 5, wherein the at least one sensor is one of a temperature sensor, a pressure sensor, and a knock sensor.

7. The retrofit kit of claim 1, further including a fuel manifold configured to be connected to the common flow regulator.

8. The retrofit kit of claim 1, wherein the at least one gaseous fuel injector includes two gaseous fuel injectors associated with each cylinder of the engine.

9. The retrofit kit of claim 1, further including at least one replacement cylinder liner.

10. The retrofit kit of claim 1, wherein the at least one gaseous fuel injector includes a converging nozzle configured to be placed in an air intake port of the cylinder.

11. A method of retrofitting a single-fuel engine having an air box to run on two different fuels, the method comprising:
mounting a first gaseous fuel injector to one of an air box wall and a cylinder liner such that the first gaseous fuel injector is capable of injecting fuel into an existing cylinder of the engine;
connecting a common flow regulator to the first gaseous fuel injector; and
connecting a fuel supply to the common flow regulator.

12. The method of claim 11, wherein mounting the first gaseous fuel injector includes positioning a nozzle of the first gaseous fuel injector inside of an air intake port in the existing cylinder liner.

13. The method of claim 11, further including connecting a controller with the common flow regulator.

14. The method of claim 11, further including connecting the controller with an existing liquid fuel injector.

15. The method of claim 11, further including mounting a second gaseous fuel injector at a side of the cylinder liner generally opposite the first gaseous fuel injector.

16. The method of claim 11, further including:
removing an existing cylinder liner from an existing engine block of the engine; and
inserting a replacement cylinder liner into the existing engine block.

17. The method of claim 16, wherein mounting the first gaseous fuel injector includes mounting via pre-drilled holes in the replacement cylinder liner.

18. The method of claim 16, further including mounting a second gaseous fuel injector at a side of the replacement cylinder liner generally opposite the first gaseous fuel injector.

19. The method of claim 18, wherein:
mounting the first gaseous fuel injector includes positioning a nozzle of the first gaseous fuel injector at a first air intake port in the replacement cylinder liner; and
mounting the second gaseous fuel injector includes positioning a nozzle of the second gaseous fuel injector at a second air intake port in the replacement existing cylinder liner.

20. A retrofit kit for converting a single-fuel engine having an air box and a plurality of cylinders to run on two different fuels, the retrofit kit comprising:
a plurality of gaseous fuel injectors positionable inside the air box;
a common flow regulator;
a fuel manifold connectable to the common flow regulator;
a plurality of injector supply lines configured to fluidly connect each injector flow regulator to the fuel manifold;
a fuel supply;
a common fuel supply line configured to fluidly connect the fuel supply to the common flow regulator;
a controller connectable to the plurality of gaseous fuel injectors and a plurality of existing liquid fuel injectors; and
at least one sensor configured to generate a signal indicative of a performance condition of the engine after conversion of the engine to run on two different fuels and direct the signal to the controller.
